(19) United States
(12) Patent Application Publication
(10) Pub. No.: US 2005/0086527 A1
(43) Pub. Date: Apr. 21, 2005

(54) System and method for tracking distribution of digital content

(76) Inventor: Miles R. Jackson, North Barrington, IL (US)

Correspondence Address: MOTOROLA INC, 600 NORTH US HIGHWAY 45, ROOM AS437, LIBERTYVILLE, IL, 60048-5343, US

(21) Appl. No.: 10/688,815

(22) Filed: Oct. 17, 2003

(51) Int. Cl. H04L 9/00

(52) U.S. Cl. 713/201

(57) ABSTRACT

A system and method for associating a list of recipient identifiers with an electronic message is provided. An application is launched in conjunction with a messaging application (207) on a messaging capable device (200). When a user initiates creation of an electronic message and enters at least one recipient's information (403) the application adds the recipient's information into a header of the electronic message (411) that is encrypted and embedded into the message. In addition a unique message identifier (409) that associates the message with a sender and recipients is added to the message. The message, header information, and any attachments are lastly encrypted into a message object (415) which cannot be edited by message recipients. Any subsequent forwarding of the message by a recipient follows a similar process such that a tree of custody of the electronic message is traceable.

### FIELD OF THE INVENTION

The present invention relates generally to trusted systems and more particularly, to a system and method for tracking distribution of messages and digital content.

### BACKGROUND OF THE INVENTION

Proprietary or confidential information can be transmitted from an originator to a recipient via corporate or public electronic messaging systems. In typical commercially available systems, once the message or content has been transmitted, the originator no longer has control over what the recipient does with the information. For example, the recipient may subsequently forward the electronic message to a second recipient. Second recipients may again forward the message, creating a tree of message recipients each having custody and control of the proprietary or confidential information.

The tree of ownership for proprietary or confidential information can expand rapidly and be difficult to track. Corporate entities can be frustrated upon learning that proprietary information intended for internal use only was, for example, published on a web site. It would be useful to be able to determine which recipient transmitted information without authorization, or to otherwise discourage inappropriate use of such information.

In David H. Crocker, Standard for the Format of ARPA Internet Text Messages, IETF RFC 822 (1982), available at http://www.ietf.org/rfc/rfc822.txt (last visited Jul. 16, 2003) updated by Network Working Group, Internet Message Format, IETF RFC 2822, (2001), available at http://www.ietf.org/rfc/rfc2822.txt (last visited Jul. 16, 2003), which is incorporated by reference herein, a format for electronic messages is provided. Crocker also describes “trace fields” which provide auditing information with respect to message routing from a first point to a second point. Id. at 20.

Although trace fields are useful for the resolution of transport layer issues, the information does not provide indication of who may have accessed the content contained within a message. The trace fields further do not indicate who had access to redirect or distribute the content of a message.

The “Simple Mail Transfer Protocol” (SMTP), is defined in Jonathan B. Postel, Simple Mail Transfer Protocol, IETF RFC 821 (1982), available at http://www.ietf.org/rfc/rfc821.txt (last visited Jul. 16, 2003), which is incorporated by reference herein. SMTP provides the “capability to relay mail across transport service environments.” Id. at 1. For example, the X.25 transport service may be utilized although RFC 821 recommends the addition of a reliable end-to-end protocol such as TCP. Id. at 47. In any case, SMTP may be used via any suitable transport service.

Employing the trace fields of RFC 822 in a system utilizing SMTP enables determination of a “route back to the sender.” RFC 822 at 20. However, this auditing information does not solve the problem of determining who had access to information contained within a message.

Therefore, a need exists for a system and method for determining who had access to the information contained within an electronic message, and more particularly a means for determining the chain of custody of an electronic message.

### BRIEF DESCRIPTION OF THE DRAWINGS

FIG. 1 is a diagram representing a number of devices having messaging capabilities, each device being connected to a network.

FIG. 2 is a block diagram of a messaging capable device in accordance with the embodiments of the present invention.

FIG. 3 is a block diagram of a message of an embodiment of the present invention.

FIG. 4 is a flow diagram illustrating a message origination operation of an embodiment of the present invention.

FIG. 5 is a message flow diagram illustrating a message tracking operation in accordance with an embodiment of the present invention.

FIG. 6 is a message flow diagram illustrating a second message tracking operation in accordance with an embodiment of the present invention.

FIG. 7 is a block diagram of a recipient identifier field of a message header in accordance with an embodiment of the present invention.

FIG. 8 is a flow diagram representing a receiving operation of an embodiment of the present invention.

FIG. 9 is a flow diagram illustrating a message origination operation for a server based embodiment of the present invention.

FIG. 10 is a flow diagram illustrating the use of audit identifiers for attachments in accordance with the present invention.

### DETAILED DESCRIPTION OF THE PREFERRED EMBODIMENTS

To address the above-mentioned need, a system and method for tracking recipient information of an electronic message are provided herein. In an embodiment of the present invention, an application reads recipient information, preferably the recipient's network address, and encrypts this information into an application message header. Additionally, any attachments to the message may also be encrypted along with the message content and header to form a message object.

The message is subsequently transmitted by the application to recipients via any one of a plurality of transport mechanisms such as, but not limited to, CDMA high speed packet data, GSM GPRS, Internet protocol (IP), ATM or any other suitable transport mechanism. Additionally the present invention may utilize SMTP for transmission of message objects or application log update information transmission.

The message object is readable by the recipient only if the recipient has a reader application for decrypting the contents of the message object. The application may be stand-alone, or may be implemented as a plug-in to an existing email reading application, such as Netscape Messenger or Microsoft Outlook.

The recipient may subsequently forward the message to others using the application. The application employs one of a plurality of transport mechanisms for forwarding messages, but not necessarily the same transport mechanism used by the message originator.

If an information recipient forwards a message, an information update will be transmitted to the message originator upon forwarding the message via a messaging application of the present invention. In some embodiments, the message application residing on the client device of the originator maintains a log of recipient identifiers corresponding to message identifiers. In other embodiments, a log of recipient identifiers corresponding to message identifiers is maintained by a server.

The present invention relates to an apparatus and method for associating a list of recipient identifiers with a message. In some embodiments, a message originator uses an application to encrypt a message and, in some embodiments, any attachments, and add at least one recipient's information to the message header.

The message is also assigned a unique message identifier. The message identifier can be unique based on a set of message identifiers generated by the application with respect to the message originator's device. Alternative embodiments employ a server that assigns the message identifier. The server further stores and associates recipient information based upon the assigned message identifier.

A first aspect of the present invention is a communications device comprising a transceiver configured to transmit and receive a message having a message identifier and a recipient identifier field. The recipient identifier field corresponds to an order of custody of the content contained within the message. The message recipients are prevented from editing the message identifier and the recipient identifier fields.

Further with respect to the first aspect of the present invention, the communications device may store a message log that records each transmitted message and is updated by update messages received back from recipient communications devices.

A second aspect of the present invention is a server, to assign and transmit message identifiers to message originating communications devices. The server comprises a database and stores records of the message identifiers with respect to each communications device that has transmitted a message. In some embodiments, the server also maintains message logs and receives updates of the message logs from communications devices. A message originator may query the server to receive a report on sent messages.

A third aspect of the present invention is a server, which may be integrated into the second aspect server, for assigning audit identifiers to attachments included in messages. The audit identifiers are uniquely associated with each recipient of a message attachment, and may also be unique with respect to each attachment.

A fourth aspect of the present invention is a method of communicating messages over a network comprising: embedding a message identifier, message originator identifier, and message recipient identifier into a message; attaching content if any, preparing headers and suitable encapsulation of the message and content; updating a message log; and transmitting the message.

A fifth aspect of the present invention is a method of tracking information custody comprising: receiving a message; re-transmitting the message to a new recipient; and transmitting a message log update to the message originator.

A sixth aspect of the present invention is a method of tracking information custody comprising: receiving a message; re-transmitting the message to a new recipient; and transmitting a message log update to a server.

A seventh aspect of the present invention is a method of constructing a message by a communication device comprising: generating a message identifier; encrypting a message header comprising the message identifier, a message originator identifier, and at least one recipient identifier; receiving an audit identifier from a server; embedding the audit identifier into a message attachment; and encrypting the attachment.

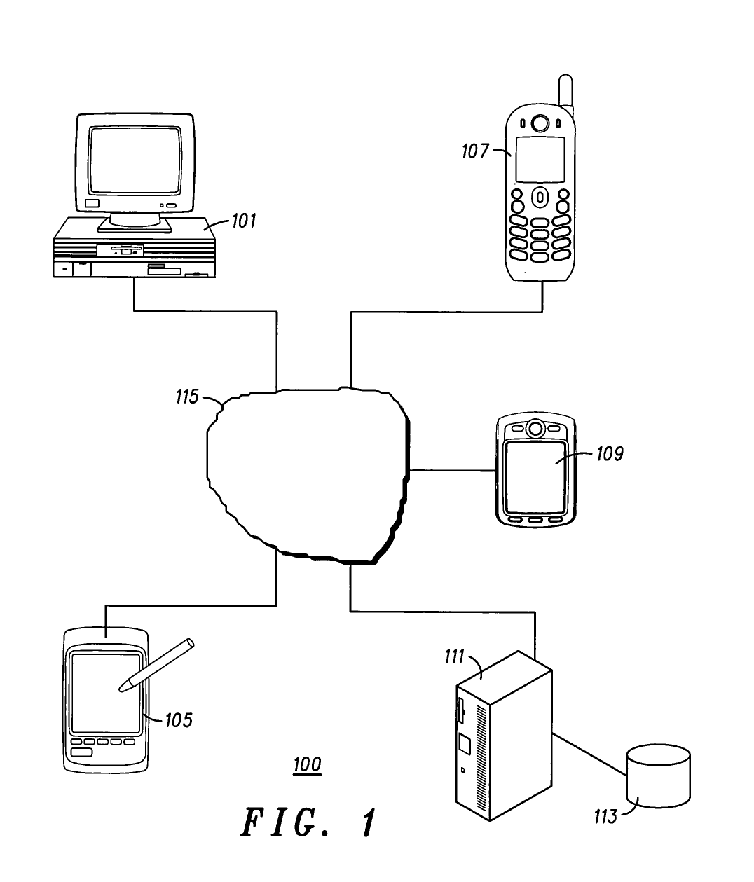

Turning now to the drawings where like numerals designate like components, FIG. 1 illustrates a network 100 in accordance with some embodiments of the present invention. In FIG. 1, various devices that can transmit and receive electronic messages are connected to network 115, which may be an intranet or the Internet, via any means known by those skilled in the art. For example, a wireless telephone 107 may be connectively coupled to the network 115 via a connection through a cellular network, or a wireless local area network (WLAN). Likewise, personal digital assistant (PDA) 109 may be connected to the network 115 via a WLAN connection.

Other devices for example, personal computer (PC) 101, or a stand-alone device dedicated to messaging functionality 105 may also be connected to the network 115 via a variety of connection means. All such devices, as illustrated in FIG. 1, may communicate with each other by sending and receiving electronic messages that may include attached content files.

FIG. 1 also illustrates a server 111 having a database 113, which is employed in some embodiments of the present invention and which can communicate with any of the devices connected to network 115.

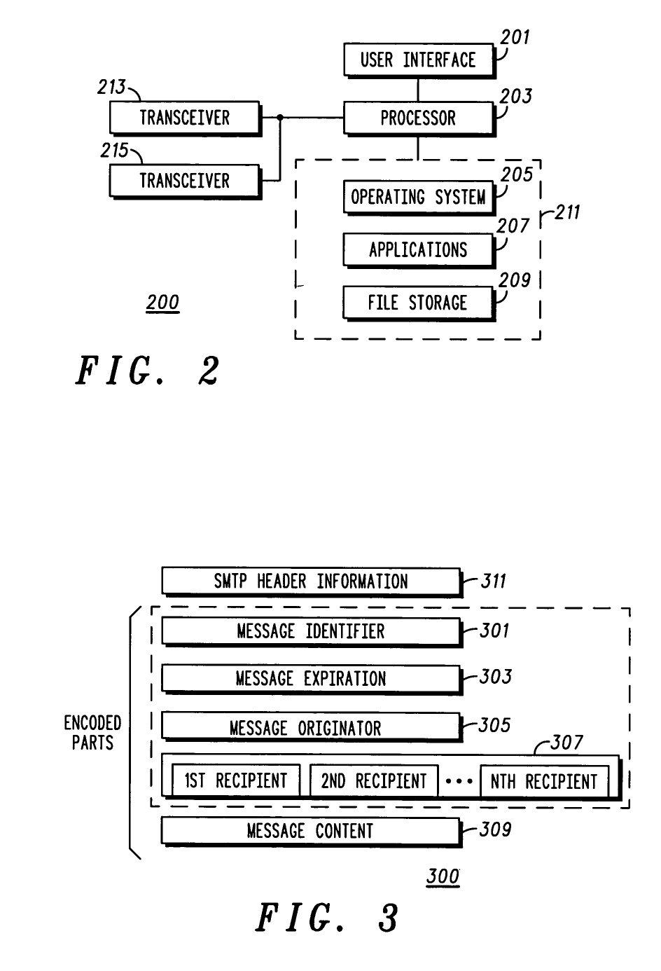

FIG. 2 illustrates details of a messaging capable device 200 in accordance with an embodiment of the present invention. In FIG. 2, a typical device is illustrated comprising a plurality of user interfaces 201, such as for example a keypad, mouse, microphone, speaker and graphical display. The plurality of user interfaces 201 are connectively coupled to a processor 203, which is further connectively coupled to a memory 211.

Memory 211 is for illustrative purposes only and may be configured in a variety of ways and still remain within the scope of the present invention. For example, memory 211 may be comprised of several elements each coupled to the processor 203. Further, separate processors and memory elements may be dedicated to specific tasks such as rendering graphical images upon a graphical display. In any case, the memory 211 will have at least the functions of providing storage for an operating system 205, applications 207 and general file storage 209 for device 200.

In one embodiment, applications 207 comprise a messaging application and a messaging application add-on employed for providing the aspects of the present invention described herein. Alternatively, applications 207 may comprise a specialized application that is compatible with operating system 205 and a messaging application.

Messaging capable device 200 also comprises at least one transceiver 213, connectively coupled to processor 203, for transmitting and receiving electronic messages over the network 115. Transceiver 213 may be suitable for wire-line communications or may be a wireless transceiver in some embodiments of the present invention. Messaging capable device 200, may also have other transceivers, such as transceiver 215, such that messaging capable device 200 may communicate over more than one interface, and more than one network.

For example, message capable device 200 may be capable of communicating via one of a cellular radio interface such as GSM and CDMA via transceiver 213, and one of a Wireless Local Area Network (WLAN) radio interface such as Bluetooth, 802.11, IrDa and HomeRF via transceiver 215.

FIG. 3 is a block diagram illustrating the basic structure of a message object 300 in accordance with an embodiment of the present invention. Message object 300 comprises an application message header further comprising a message identifier 301, a message expiration time 303, a message originator field 305, and a recipient chain 307. In some embodiments message object 300 will further comprise message content 309.

Message object 300 is encrypted and cannot be viewed by recipients. More importantly, message object 300 cannot be edited by recipients. Message content 309 which is also encrypted is viewable by recipients, but only those recipients who have the application of the present invention installed on a client device. It is to be understood that any suitable encryption scheme may be employed in the embodiments and remain within the scope of the present invention. Further, the use of certain encryption schemes may necessitate the inclusion of other message components not illustrated by FIG. 3, in order to properly implement the encryption scheme. Therefore, FIG. 3 is for illustrating the components necessary to practice the present invention, independent of the particular encryption scheme employed by those of ordinary skill in the art.

Message object 300 may be transmitted over network 115 using any of a plurality of transport mechanisms such as, but not limited to IP, TCP, UDP, ATM, CDMA packet data, GSM GPRS, and SMTP. FIG. 3 illustrates that message object 300 may appear as an encoded part of an SMTP message, for example a MIME encoded part, in which the message is transported using SMTP and employing an appropriate SMTP header 311.

The IETF publications, N. Freed, MIME (Multipurpose Internet Mail Extensions) Part One: Mechanisms for Specifying and Describing the Format of Internet Message Bodies, IETF RFC 1521 (1993) available at http://www.ietf.org/rfc/rfc1521.txt (last visited Jul. 16, 2003) and preceding RFCs, 1341 and 1342, which are incorporated by reference herein, “provide facilities to include multiple objects in a single message.” Returning to FIG. 3, message identifier 301 message expiration 303, message originator 305, recipient list 307, and content 309 may be MIME encoded parts, in accordance with RFCs 1521, 1341, and 1342, in some embodiments of the present invention.

Alternatively, message object 300 may form a first MIME encoded part, and message content 309 may form a second MIME encoded part. In a second alternative, message object 300 and message content 309 may be combined into a single MIME encoded part in some embodiments of the present invention.

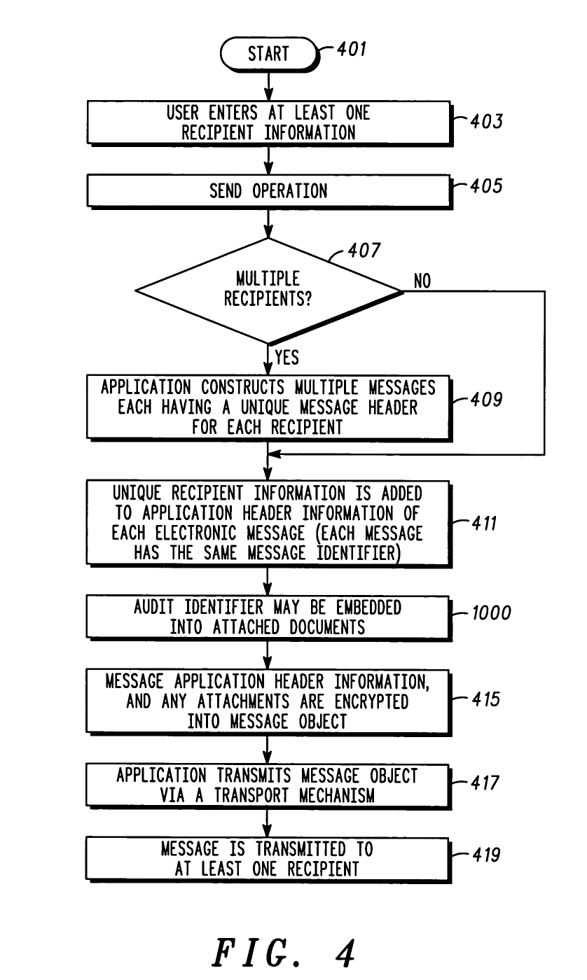

Turning now to FIG. 4, a message origination operation of an embodiment of the present invention is illustrated. In block 401, a user operating any one of the client devices illustrated in FIG. 1, launches a messaging application and also a message tracking application. The user employs the message tracking application to create an electronic message. The message tracking application generates a message identifier, unique for the particular message with respect to the user, and adds it to an application message header. When the user enters in the address information of at least one recipient in 403, the application also adds the entered recipient information into the application message header. After the user has created a message and added any attachments, the user may send the message using the application as shown in block 405.

If the message is intended for multiple recipients as shown in 407, then the application will construct a separate message for each individual as in 409. The operation of 409 will be transparent to the user however, such that the user perceives that he is preparing only a single message to multiple recipients.

It is important to note that it is a critical aspect of the present invention that a separate message is constructed for each intended recipient. The separate messages allow for construction and logging of a “chain of custody” for transmitted information thereby realizing the benefits of the present invention. In the embodiments in which SMTP is utilized for example, the application of the present invention will construct, in addition to the message header contained by message object 300, an appropriate SMTP header for each individual message recipient. The application will subsequently transmit the group of messages using SMTP, transparent to the message originator.

In some embodiments, the message originator will perceive, via the user interface, transmission of only a single message to multiple recipients via the application of the present invention. However, it is not critical whether the message originator perceives, via the user interface, that multiple messages are transmitted, provided that the action of transmitting the multiple messages is performed by the application. The user must only create a single message for transmission to multiple recipients, and specify the multiple recipients as described above.

In 411, for either the case of a single recipient, or the case of multiple recipients, the recipient information is added to the single or multiple, message application headers respectively. In the multiple message case, the recipient identifier field 307 of each message constructed by the application will contain only the information specific to the intended recipient of a particular message. The application message header of message object 300 for each constructed message will therefore be unique to the recipient based upon the combination of the message identifier 301, the message originator 305, and the initial entry in the recipient identifier 307 field.

It is to be noted that some users of the application of the present invention may utilize message identifiers that are identical to other users. However, the generated message object 300 will always be unique to a message and user based upon the combination of the message originator field 305 with the message identifier field 301.

If the user included attachments with the message prior to sending in 405, the attachments are encrypted as message content 309, along with the application message header 300 (301, 303, 305, and 307).

In some embodiments, attached documents also contain the application message header (301, 303, 305, and 307) information embedded within the documents via the application of the present invention. For example, a text document may have a white text field on a white background as part of the document title page, document header or footer. If the attachment is a spreadsheet, a hidden cell or cells may be used, located in an unused area of the spreadsheet. Alternatively, for file formats which support macros, a macro definition may contain the information. It is to be understood that any suitable means for embedding information into an attached document may be employed in embodiments of the present invention.

In an alternative embodiment, the attached documents may contain an “audit identifier” which corresponds to the application message identifier 301, message originator 305, and recipient list 307. The audit identifier is a unique designator that associates a particular attachment with a particular message. In the embodiments in which such document tagging is utilized, this operation occurs in block 1000. The advantage of using such an audit identifier is that it would require less data bits than would the combination of message identifier 301, message originator 305, and recipient list 307 if actually input into an attachment. This is particularly important for attachments that have been forwarded to many recipients such that recipient list 307 is quite large.

The message content 309 encryption operation occurs in block 415. In 417, the application transmits the message object 300, and message contents 309 in the embodiments in which the message contents 309 are separate from the message object 300, using an appropriate transport mechanism.

For example, the application may construct one or more appropriate SMTP headers 311 and transmit the one or more messages using SMTP. In this case, the application may append the application message header information of message object 300 and the message contents 309 as for example MIME encoded parts of the SMTP message. Alternatively, the application may construct appropriate encapsulation for transmission via cellular packet data services for example, CDMA high speed packet data or GSM GPRS. Any suitable transport mechanism may be employed by any of the embodiments of the present invention. In 419, a message is transmitted over any of a plurality of transport mechanisms to at least one recipient.

FIG. 5 illustrates a message tracking operation of the present invention via use case 500 which may occur in accordance with some embodiments. In FIG. 5, a message originator “O1” performs, via the application of the present invention, a send operation 501 and sends a message to a first recipient “R1.” The send operation consists of a message object with content “A” corresponding to a first message identifier.

The message identifier is generated by the application residing on the client device of O1. The application further constructs or appends a message log 509, which resides in file storage 209 of the O1 client device. The message log 509 comprises records of each message transmitted. The transmitted messages are identified by the information contained in message object 300, specifically the message identifier 301 and the recipient identifiers 307. The message log 509 may also comprise the message expiration 303, and a description of message content 309, or a link, such as but not limited to an iconic link, a hypertext link or other appropriate mechanism, to the message content 309 residing in file storage 209 of the Ol client device. In any case, O1 has the capability to associate and retrieve message content 309 which corresponds to a previously transmitted message having a message identifier 301, and recorded in message log 509.

The first recipient, R1, may subsequently forward the content to others using the application of the present invention. For example, R1 may forward content A to a second recipient R2 503. The application residing on R1's client device will transmit a message log 509 update message 511 to the client device of originator O1. The message log 509 update message 511 will contain at least the message identifier and the recipient identifier field. However, the recipient identifier field will be modified to indicate that R2 was a recipient of the message from R1. Thus, a discernable chain of custody for the information is established via the mechanism of message log 509.

Message log updates may be transmitted using a variety of methods. In some embodiments, an SMTP message is transmitted from the R1 client application to the O1 client application. The transmission is transparent to R1 such that R1 will not be made aware that a message has been transmitted upon forwarding a tracked message. In this case, O1 will receive the message and open it using the application of the present invention. The application will then update message log 509. The message may contain notification text informing O1 of the transaction for example, that R1 has forwarded the message to R2. The notification aspect is not required however, provided that the message log is updated by the application of the present invention upon opening of the received update message.

A second embodiment for message log 509 updating is one in which the application of R1 opens a communications port, for example a TCP/IP port, to the application of O1 and updates the message log 509 using a proprietary communication protocol.

Returning to FIG. 5, R2 may add reply text, content “B,” to the message from R1. In this case, because R1 already had possession of the initial information, content “A,” as determined by the application header information of message object 300 of the original message, no update is transmitted to message log 509. However, if R1 forwards the reply from R2 to R3, then a message log 509 update will be transmitted from R1 to O1. This is because R3 is a new recipient of the information corresponding to the application message header of message object 300 of the original message transmitted by O1.

It is to be understood that as a message is transmitted, forwarded, or replied to using the application of the present invention, the recipient identifier field 307 of the application message header contained within the message object 300 is updated. The result is that each instance of a message has an associated chain of custody for the information contained. Because updates are also transmitted to message log 509 of the originator when the message is transmitted, typically via forwarding, to new recipients, the originator maintains awareness, via access to the message log, of the status of the information chain of custody.

FIG. 6 illustrates a second use case 600 which may occur in accordance with some embodiments. In FIG, 6 similar to FIG. 5, O1 sends a content “A” to R1 601. R1 forwards the content to R2. A message log 609 is resident in a memory of the O1 client device. The R1 application transmits a message log 609 update 611 to the message originator O1.

Similar to use case 500 illustrated in FIG. 5, in use case 600, R2 also replies to R1. No message log update is transmitted for the reply from R2 because RI already had possession of the information. The application of the R2 client device determines that the message log update is not required based upon the information contained in the application message header information of message object 300. Particularly, with respect to the example illustrated by FIG. 6, R1 is the sender of the message to R2 via forward operation 603. Further R1 is a recipient of the reply 607 from R2. Therefore, a message log update is not required because R1 already had possession of the information illustrated as “content A.” The message originator O1, transmitted “content A” to R1 via send operation 601.

However, when R2 replies to R1, R2 may also use “carbon copy” (cc) or “blind carbon copy” (bcc) features and transmit the message content to R3 via “cc/bcc” operation 605. In this case, because R3 is a new recipient, a message log update 613 is transmitted to the application of the O1 client device such that message log 609 may be updated. The message originator thus maintains a log of the chain of custody of the information contained in the message.

Although FIG. 5, and FIG. 6 represent specific use cases, it is to be understood that other use cases exist that are also in accordance with the operation of the present invention. Therefore, FIGS. 5 and 6 are for illustrative purposes only and are not to be construed as limitations on use cases of the embodiments disclosed herein.

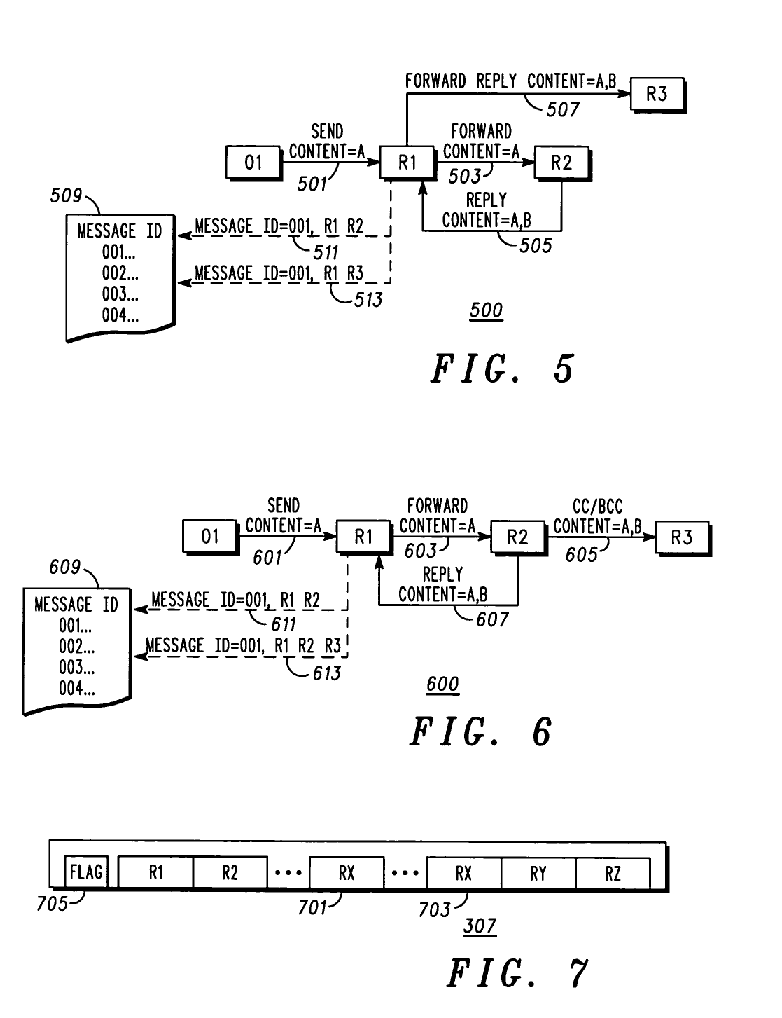

FIG. 7 provides further details with respect to message log updates based upon the recipient identifier field 307. In FIG. 7, the recipient identifier field 307 is shown having first and second recipients, RI and R2 respectively. As a message is transmitted from recipient to recipient, the length of recipient identifier field 307 increases.

Each time a message is transmitted to a recipient, that particular recipient's information is added to recipient identifier field 307. Therefore, it is possible that the same recipient may have multiple entries within recipient identifier field 307. For example, as shown in FIG. 7, a recipient Rx may have two entries 701 and 703.

The recipient Rx, may then forward the message to recipient Ry. Recipient Ry may then forward the message to recipient Rz. The resulting recipient identifier field 307 would then be as illustrated in FIG. 7.

Recipient Rz may forward the message to Rx. However, in the example illustrated by FIG. 7, Rx was a previous recipient of the message at two points in the chain of custody, particularly entries 701 and 703. In some embodiments of the present invention, the application determines that a new recipient was a previous recipient. In that case, the application would not need to send a message log update to the originator. Therefore, with respect to the above described embodiment, if recipient Rx received the message with recipient identifier field 307 having entry 703 and entry 701, then the application would not send a message log update to the message originator.

In an alternative embodiment, the type of message log update received by a message originator is settable by the message originator when preparing a message. For example, the recipient identifier field 307 may also include flag 705. The flag 705 indicates to a receiving client application the type of message update the message originator wishes to receive and takes the appropriate action. For example, the flag 705 may indicate that the message originator wishes to receive message log updates only for new recipients, but not for previous recipients as described above.

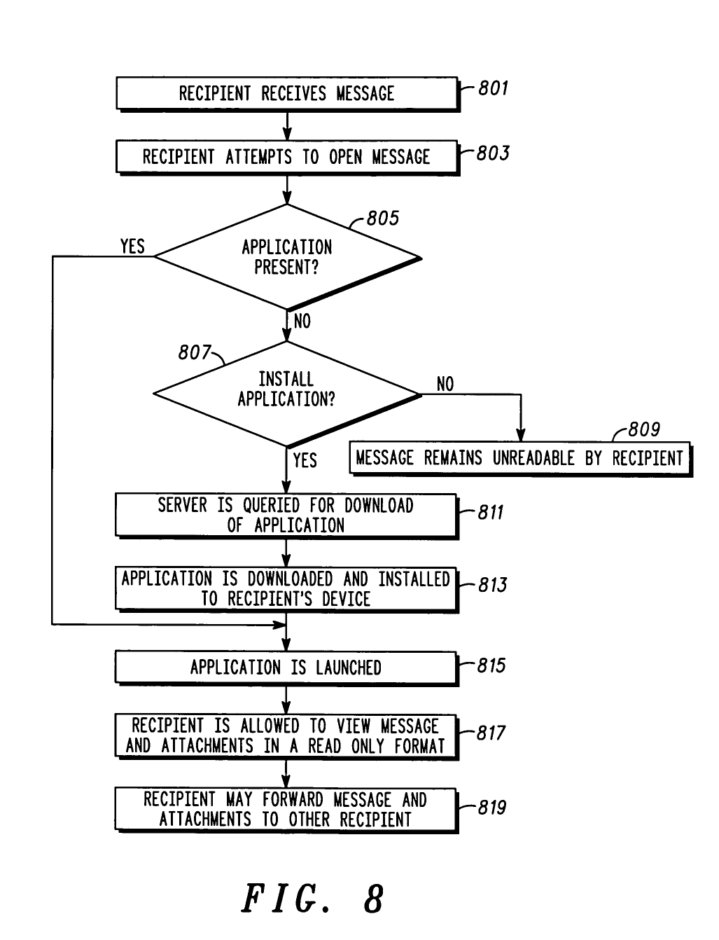

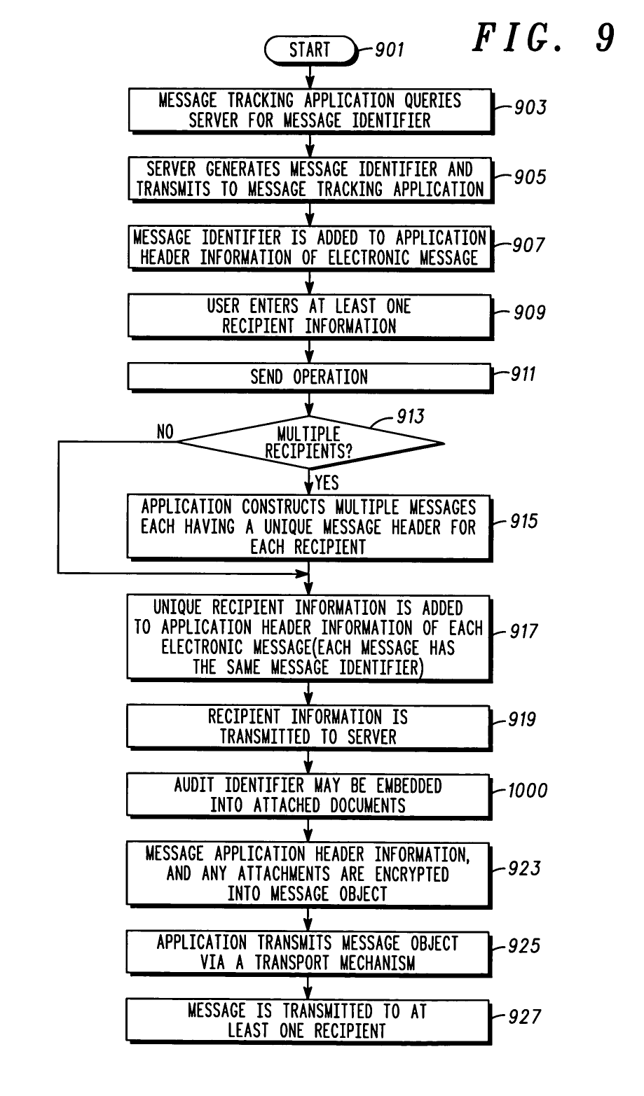

In FIG. 8 a receiving operation of an embodiment is illustrated. Initially, in 801, a recipient receives the message via a messaging system such as for example email. In 803, the recipient attempts to open the message via a messaging application. If the recipient does not have the application of the present invention installed on the recipient's messaging device, then the message will not be readable by that recipient. In embodiments where SMTP is used as the transport mechanism, the message may be defined as specific MIME types for example, that would not be accessible without the required application. Because the message contents and attachments are encrypted, it is further ensured that the message will not be readable by recipients not having the required application.

The unknown message type will cause a client side query 805 on the recipient device to test for the presence of the application. If the application is not present, a query box is presented to the recipient 807 asking whether the required application should be installed. If the recipient rejects the installation, the message and its contents remain unreadable by the recipient's messaging application as illustrated in block 809. If the recipient elects to install the application, a network connection is established between the recipient's device and a server 811. The server then provides a download of the required installation files 813, and installation proceeds. It is to be understood that the download may by provided by an e-commerce system requiring a payment or account credit prior to providing the application.

It is also to be understood that other suitable installation mechanisms may also be used and remain in accordance with the embodiments of the present invention. For example a CD or other removable media may be utilized for the purpose of installing the application on a device and still remain within the scope of the present invention.

After installation is completed, the user may launch the application 815, by for example, clicking a mouse cursor over an iconic representation of the message. The recipient may then view the message and attachments in a read only format 817. Additionally, the recipient may add to the message and forward copies of it to other recipients 819. It is an important aspect of the embodiments that each time the recipient forwards the message as shown in block 819, an origination process similar to that illustrated in FIG. 4 is invoked. Specifically, as illustrated in block 411, recipient information is added to the recipient identifier field 307 of the application message header of message object 300. Additionally as noted with respect to FIG. 4 block 407, a recipient may forward, cc, or bcc multiple recipients. In the case of multiple recipients, the application will always construct multiple unique message objects 300 and thus a unique message for each intended recipient. This construction occurs transparent to the user.

The message log update transmitted for multiple recipients may occur in a batch in some embodiments, such that the message log is updated with all multiple recipients simultaneously. However, in some embodiments the update may be performed by an individual update message for each of the multiple recipients.

Returning to FIG. 8, if a message recipient already installed the application as described above, and attempts to open a message generated by the application 803, the query 805 will recognize the electronic message as a known message type. In this case, the application is launched 815, and the recipient is able to view the message as illustrated in block 817. Further, the recipient may forward the message as illustrated in block 819.

Server Based System Description

In some embodiments of the present invention a server 111 provides the message identifier to the application of a client device. As illustrated in FIG. 1, server 111 comprises or is connected to a database 113 that stores the message identifiers and also associates assigned message identifiers with their respective assigned message originators. The server may either repeat message identifiers for each user, or generate a globally unique message identifier for each user of the system.

Additionally, the server may maintain the message logs 509 and 609 as illustrated by FIGS. 5 and 6 respectively. In some embodiments, the message originator is entitled to access and view the message logs via the application of the present invention, similar to the cases illustrated by FIGS. 5 and 6. However, in other embodiments the message logs can only be accessed via an administrative function of the application in which the user would require a special access code.

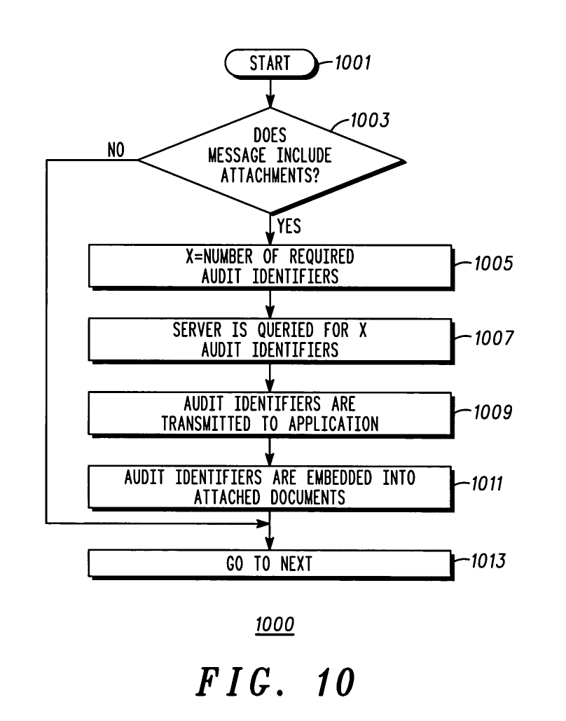

FIG. 9, which is similar to FIG. 4 with respect to basic operation of the application, illustrates embodiments in which a server is utilized. In 901 a message originator launches a message tracking application of the present invention on a client device and initiates creation of a message.

In 903, the message tracking application will query server 111 for assignment of a message identifier. In 905, the server responds with a message identifier. It is to be understood that the message identifier query and response may be via any of a plurality of mechanisms and remain within the scope of the present invention.

In 907, the application inserts the message identifier into the message identifier field 301 of message object 300. The message originator will enter the recipient information in 909, and if there are multiple intended recipients, the application will construct the appropriate multiple messages in 913, 915, and 917 in a manner similar to that described with respect to FIG. 4.

In 919, the recipient information is transmitted from the message originator's client device to server 111 for storage in database 113. In 1000, an audit identifier may be embedded into the attachments. In 923, 925, and 927 the application proceeds in a manner similar to that described with respect to FIG. 4.

FIG. 10 illustrates details of an alternative embodiment that employs document tagging such as that illustrated in FIGS. 4 and 9, block 1000. FIG. 10 represents the subset of operations that occur when a message originator includes attachments to a message employing the operations of block 1000.

In FIG. 10 a server and database are employed for the purpose of generating and storing audit identifiers. The server may also be used for maintaining logs of recipient identifiers as previously described with respect to server 111. Therefore, an audit identifier server may be a part of server 111, or may be a separate server accessible via network 115. Various server and database architectures may be employed and remain within the scope of the present invention.

Returning to FIG. 10, an audit identifier associates a document attachment to the message header information contained in message object 300, specifically to the message identifier 301, the message originator 305, and the recipient list 307. Therefore, an audit identifier has no understandable meaning to a recipient of the documents even if the recipient is able to view the audit identifier. One benefit of embedding an audit identifier is that although it represents the complete information contained in a message object 300 it requires less data. As a message is forwarded the recipient identifier field 307 will increase in size, yet an audit identifier may be limited to a set number of characters.

Returning to FIG. 10, a message originator includes attachments with a message prior to block 1001, at which point, the application detects the attachments and invokes the operations illustrated as block 1000. The application tests whether attachments have been included with the message in 1003.

If no attachments are present then the application returns to the primary routine in 1013. For example, the application returns to the routines illustrated by FIGS. 4 and 9 after block 1000.

If multiple attachments exist then the application may query the server for an audit identifier for each one. Therefore, in 1005 the application determines the number of recipients and may also determine the product of the number of recipients and the number of attachments. Therefore, the number of required identifiers may be the total number of attachments which is the product of the number of attachments and the number of recipients intended to receive the attachments. However, the required number of audit identifier may simply be equal to the number of recipients. Each attachment will at least have an audit identifier unique to a recipient and may have an audit identifier unique to the combination of the specific attachment and a recipient.

In 1007, the server requests the appropriate number of audit identifiers. The request comprises information from the message object 300 for each required audit identifier. In 1009, the server transmits the audit identifiers to the application and in 1011 the audit identifiers are embedded into the corresponding attachments. In block 1013, the application returns to the routines illustrated by FIGS. 4 and 9 after block 1000.

In an alternative embodiment, the server is queried separately for each audit identifier, and blocks 1009, 1011, and 1013 are repeated for each attachment prior to sending the next query. It is more desirable and efficient however, to send a single query for all attachments at once as illustrated in block 1007.

It is to be understood that the embedding of an audit identifier into an attachment may be dependent upon the document type and may employ additional algorithms for such embedding. For example, the application may detect that the attachment is an image file and employ steganographic techniques to embed the audit identifier into the image. Other techniques for various attached file types may be employed and remain within the scope of the present invention.

An additional benefit derived from the described embodiments is that, because message recipients would be aware of the aspect of embedded forwarding recipient address information, recipients would be more likely to adhere to message distribution policies. For example, an administrative assistant who received a message on her supervisor's behalf would be less likely to forward the message to others without considering whether the information is sensitive or proprietary.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A communication device for communicating messages over a network comprising:
at least one transceiver, configured to transmit and receive a message having a message identifier and a plurality of recipient identifiers wherein the order of said plurality of recipient identifiers corresponds to an order of custody of said message by recipients, and wherein recipients are unable to edit said plurality of recipient identifiers.

2. The communication device of claim 1, further comprising a memory, configured to store a message log associating a transmitted message with said message identifier and with said plurality of recipient identifiers.

3. The communication device of claim 2, wherein:
said transceiver is further configured to receive, from a recipient of said message, an update of said message log.

4. The communication device of claim 1, wherein said transceiver is further configured to transmit and receive said message via a plurality of transport layer mechanisms.

5. The communication device of claim 1, wherein said transceiver is further configured to encapsulate said message in accordance with a protocol such that said message may be transmitted and received using said protocol.

6. The communication device of claim 1, wherein said transceiver is further configured to transmit a report to a message originator after transmitting said message wherein said message was previously received from said message originator.

7. The communication device of claim 1, wherein said transceiver is further configured to transmit a report to a message originator after transmitting said message wherein said message was previously received from a message recipient.

8. The communication device of claim 1, wherein said transceiver is further configured to receive, from a server, said message identifier and add said message identifier into said message prior to transmission of said message.

9. The communication device of claim 1, wherein said transceiver is further configured to transmit a report to a server after transmitting said message wherein said message was previously received from said message originator.

10. The communication device of claim 1, wherein said transceiver is further configured to transmit a report to a server after transmitting said message wherein said message was previously received from a message recipient.

11. The communication device of claim 1, wherein said transceiver is further configured to receive, from a server, an audit identifier and add said audit identifier into a message attachment prior to transmission of said message.

12. The communication device of claim 11, wherein said audit identifier uniquely corresponds to the combination of said message identifier, said order of said plurality of recipient identifiers, and a message originator identifier.

13. The communication device of claim 1, wherein said message comprises an encrypted message header that cannot be edited by recipients.

14. The communication device of claim 13, wherein said encrypted message header further comprises:
a message identifier field;
a message originator field; and
a recipient identifier field for containing said plurality of recipient identifiers.

15. The communications device of claim 14, wherein said encrypted message header further comprises a message expiration field.

16. The communication device of claim 14, wherein said recipient identifier field further comprises a flag field for indicating a message originator preference setting.

17. A server comprising:
a processor configured to assign and transmit a message identifier to a message originator communications device via a network; and
a memory configured to store a plurality of said message identifiers wherein each of said message identifiers is associated with a message transmitted by said message originator communications device.

18. The server of claim 17 wherein said processor is further configured to receive a message log update from a recipient communications device that had received said message.

19. The server of claim 18 wherein said processor is further configured to provide a message log report to a said message originator communications device.

20. A server comprising:
a processor configured to assign and transmit an audit identifier to a message originator communications device via a network; and
a memory configured to store a plurality of said audit identifiers wherein each of said audit identifiers is associated with a message attachment transmitted by said message originator communications device.

21. The server of claim 20 wherein said audit identifier uniquely corresponds to the combination of a message identifier, an order of recipient identifiers, and a message originator identifier.

22. The server of claim 21 wherein said audit identifier further comprises an identifier specific to said message attachment.

23. A method of communicating messages over a network comprising:
embedding into a message a message identifier, message originator identifier, and message recipient identifier;
attaching content if any to said message;
preparing headers and suitable encapsulation of said message and said content in accordance with a communication protocol;
updating a message log; and
transmitting said message to a recipient using said communication protocol.

24. A method of tracking information custody comprising:
receiving a message;
re-transmitting said message to at least one recipient; and
transmitting a message log update to a message originator.

25. The method of claim 24, wherein said message log update comprises a message identifier and a recipient identifier for said recipient.

26. A method of tracking information custody comprising:
receiving a message;
re-transmitting said message to at least one recipient; and
transmitting a message log update to a server.

27. The method of claim 26, wherein said message log update comprises a message identifier and a recipient identifier for said recipient.

28. A method of constructing a message by a communications device comprising:
generating a message identifier;
adding said message identifier into a message header;
adding a message originator identifier to said message header;
adding at least one recipient identifier to said message header; and
encrypting said message header.

29. The method of claim 28, further comprising:
receiving from a server an audit identifier;
embedding said audit identifier into a message attachment; and
encrypting said message attachment.
